(19) United States
(12) Patent Application Publication
(10) Pub. No.: US 2026/0155284 A1
(43) Pub. Date: Jun. 4, 2026

(54) SINTERED MAGNET CONTAINING RARE EARTH ELEMENTS

(71) Applicants: HYUNDAI MOTOR COMPANY, Seoul (KR); KIA CORPORATION, Seoul (KR); STAR GROUP IND. CO., LTD., Daegu (KR)

(72) Inventors: Seok-Jin HA, Hwaseong-si (KR); Nyeon-Han HONG, Hwaseong-si (KR); Jae-Young CHOI, Hwaseong-si (KR); Min-Geun JOO, Hwaseong-si (KR); Sang-Hyub LEE, Daegu (KR); Dong-Hwan KIM, Daegu (KR); Koon-Seung KONG, Daegu (KR)

(21) Appl. No.: 19/098,665

(22) Filed: Apr. 2, 2025

(30) Foreign Application Priority Data
Nov. 29, 2024 (KR) 10-2024-0175131

(51) Int. Cl. H01F 1/057; H01F 41/02; H02K 1/02

(52) U.S. Cl. CPC H01F 1/0577; H01F 41/0293; H02K 1/02

(57) ABSTRACT

A sintered magnet including one or more rare-earth elements is partitioned into three or more magnets. The three or more magnets include pair of first magnets disposed at ends of the sintered magnet and made of a first material, and a second magnet made of a second material different from the first material. By applying a permanent with a high coercive specification to the ends relatively vulnerable to a reverse magnetic field and applying a permanent with a low coercive force specification in comparison to the edges to a central portion thereof, it is possible to reduce the use of heavy rare-earth elements and manufacturing process cost for manufacturing partitioned magnets.

### CROSS-REFERENCE TO RELATED APPLICATION

This application claims priority to Korean Patent Application No. 10-2024-0175131, filed on Nov. 29, 2024, which is incorporated herein by reference in its entirety.

### TECHNICAL FIELD

The present disclosure relates to a sintered magnet that includes rare-earth elements and configured to be used in a motor.

### BACKGROUND

FIG. 1 illustrates an example of a driving motor including a permanent magnet 2 provided on a rotor 1 and a coil 4 inserted into a stator 3.

As power and the number of revolutions of driving motors for a hybrid electric vehicle (HEV) and an electric vehicle (EV) increase, NdFeB sintered magnets with magnetic properties 3 to 5 times higher than ferrite magnets may be used.

In some cases, when the driving motor operates, eddy currents may be generated inside the permanent magnet due to low resistivity of the NdFeB sintered magnet, which causes a rise in a temperature of the permanent magnet.

The rise in the temperature of the permanent magnet due to the loss of the eddy current may degrade the magnetic properties of the permanent magnet and cause irreversible demagnetization at high temperatures.

In some cases, a permanent magnet may be partitioned, and the partitioned magnets are adhered to reduce a movement path of the eddy current inside the magnet, thereby reducing the amount of loss of the eddy current.

When the partitioned permanent magnets are manufactured, partitioning and adhering processes may increase a process cost in comparison to manufacturing unpartitioned permanent magnets, and thus it is important to minimize an increase in the process cost in comparison to the conventional unpartitioned magnets when the partitioned magnets are manufactured.

An internal permanent magnet (IPM) type driving motor used in vehicles generates a rotational motion through the interaction between a magnetic field generated by a permanent magnet of a rotor and a reverse magnetic field generated by a coil of a stator in a direction opposite thereto. In some cases, the reverse magnetic field may be concentrated on an end of the permanent magnet at which magnetic resistance inside a rotor core is the weakest, thereby making the end of the permanent magnet vulnerable to demagnetization in comparison to a central portion thereof.

In some cases, partitioned magnets adopt equal coercive force specifications applied to all parts, and an excessive coercive force may be applied to the central portion in which demagnetization may not occur easily.

This leads to the use of heavy rare-earth elements, thereby increasing the manufacturing cost of the permanent magnet.

### SUMMARY

The present disclosure describes reducing the use of heavy rare-earth elements when partitioned magnets are manufactured and reducing a manufacturing process cost by applying a permanent magnet with a high coercive force specification to an edge, which is relatively vulnerable to a reverse magnetic field, and applying a permanent magnet with a low coercive force specification to a central portion thereof in comparison to the edges.

According to one aspect of the subject matter described in this application, a sintered magnet includes one or more rare-earth elements. The sintered magnet is partitioned into three or more magnets, where the three or more magnets include a pair of first magnets disposed at ends of the sintered magnet, respectively, the pair of first magnets being made of a first material, and a second magnet disposed between the pair of first magnets, the second magnet being made of a second material different from the first material.

Implementations according to this aspect can include one or more of the following features. For example, coercive force of each of the pair of first magnets may be different from coercive force of the second magnet. In some implementations, the one or more rare-earth elements may include at least one of neodymium (Nd), Praseodymium (Pr), Lanthanum (La), Cerium (Ce), Holmium (Ho), Dysprosium (Dy), or Terbium (Tb). For instance, the one or more rare-earth elements are neodymium (Nd).

In some implementations, the second magnet is bonded between the pair of first magnets. In some examples, the sintered magnet may be a permanent magnet disposed in a driving motor of an electric vehicle. In some examples, the coercive force of the second magnet is less than the coercive force of each of the pair of first magnets. For instance, the coercive force of each of the pair of first magnets is greater than 25 kOe, and the coercive force of the second magnet is greater than 24 kOe.

In some implementations, a length of the second magnet may be greater than a length of each of the pair of first magnets.

In some implementations, the sintered magnet of the present disclosure is a partitioned permanent magnet made of different materials, which considers a magnetic circuit of a rotor of a driving motor. The sintered magnet of the present disclosure can reduce the cost in comparison to other magnets by applying a high coercive force specification material to only ends on which a reverse magnetic field is concentrated in comparison to a central portion thereof.

In addition, it can be possible to improve assemblability when the permanent magnet is manufactured by differently adopting the sizes of both ends and the central portion thereof.

It can be possible to prevent mixing of the permanent magnet by differently adopting the size of the central portion thereof.

### BRIEF DESCRIPTION OF THE DRAWINGS

FIG. 1 illustrates an example of a permanent magnet in a motor in prior art.

FIG. 2 illustrates a permanent magnet of Comparative Example 1 in prior art.

FIG. 3 illustrates a permanent magnet of Comparative Example 2 in prior art.

FIG. 4 illustrates an example of a permanent magnet according to the present disclosure.

FIG. 5 illustrates an example of a permanent magnet according to the present disclosure.

### DETAILED DESCRIPTION

For a full understanding of the present disclosure, operational advantages of the present disclosure, and objects to be achieved by practicing the present disclosure, reference should be made to the accompanying drawings, which illustrate example implementations of the present disclosure, and contents described in the accompanying drawings.

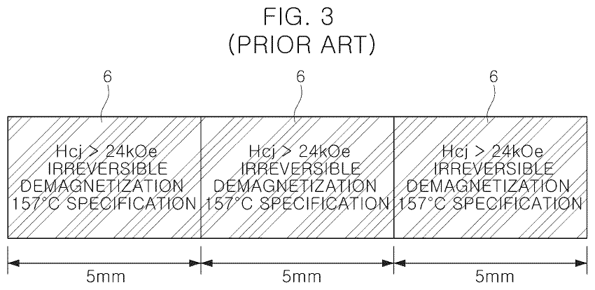

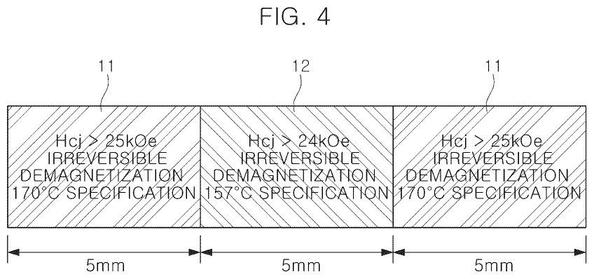

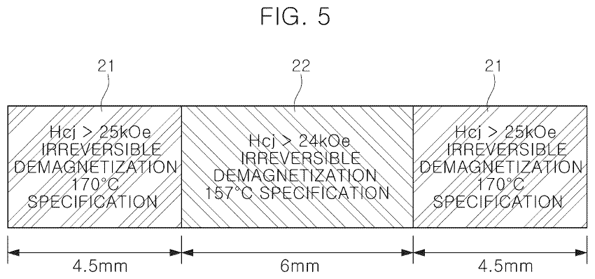

FIG. 2 illustrates a permanent magnet of Comparative Example 1, and FIG. 3 illustrates a permanent magnet of Comparative Example 2. FIG. 4 illustrates an example of a permanent magnet according to the present disclosure, and FIG. 5 illustrates an example of a permanent magnet according to the present disclosure.

Hereinafter, a sintered magnet including rare-earth elements of the present disclosure will be described with reference to these drawings.

In some implementations, the rare-earth elements may be at least one selected from neodymium (Nd), Praseodymium (Pr), Lanthanum (La), Cerium (Ce), Holmium (Ho), Dysprosium (Dy), and Terbium (Tb).

The present disclosure may help reduce the use of heavy rare-earth elements and a manufacturing process cost of partitioned magnets by adopting two types of permanent magnets with different coercive force specifications (coercive force: both ends>central portion) in a process of manufacturing NdFeB sintered partitioned magnets using diffusion of the heavy rare-earth elements. In addition, by differently adopting sizes of the central portion and edges, it can be possible to prevent mixing and improve assemblability when the partitioned magnets are manufactured.

For example, in Comparative Example 1, an alloy with an average thickness of about 0.3 mm was prepared by loading an alloy with a composition of REx-By-TMz-FeBal (RE=rare-earth elements, TM=3d transition element, x=31 wt %, y=1 wt %, and z=2 wt %) into an induction heating crucible, melting the alloy through heating, and then cooling the alloy using a rotating Cu wheel. Such an alloy strip was loaded into a vacuum chamber for coarse pulverization and then maintained in a hydrogen atmosphere to perform coarse pulverization through volume expansion of a Nd-rich phase present in a microstructure of the alloy through hydrogen absorption. Thereafter, the coarse pulverization was completed by vacuum exhaust at a temperature of 550° C. in order to remove residual hydrogen present in the alloy.

The coarsely pulverized powder was added to a jet mill process in order to finely grind the powder. In addition, by maintaining an RPM of a classifier at 3300 to 3500 during grinding, powder with an average particle size (SMD) of 2.8 to 3.0 μm was manufactured. Thereafter, the powder was supplied in an amount of about 1.8 to 2.0 g/cc to minimize a friction force between the powders through magnetic field orientation and secure a sufficient forming density. In this case, the density of the formed body was set to 4.0 to 4.1 g/cc. A sintered magnet with a sintering density of 7.55 g/cc was manufactured by loading the formed body into a sintering furnace under a sealed system to not be in contact with oxygen and maintaining the sintering furnace at 1070° C. for 4 hours at a maximum vacuum of about 5 to 10 torr.

Thereafter, the following grain boundary diffusion processes were each performed to improve the coercive force characteristics of the sintered magnet. After immersing a 15*5*5 mmT magnet workpiece in an alkaline degreasing solution, oily components on a surface of the magnet were removed, and the magnet was washed several times with distilled water to completely remove the remaining degreasing agent.

A ratio of Tb-Hydride and alcohol was adjusted to 50%: 50%, and they were mixed evenly to prepare a slurry of a heavy rare-earth compound, and then the prepared slurry was sprayed so that the heavy rare-earth compound was evenly applied to selected two surfaces (2 surfaces) of the magnet.

To diffuse the coated heavy rare-earth compound into the grain boundaries inside the magnet, the coating body was loaded into a heating furnace, heated in an argon (Ar) atmosphere, and maintained at 900° C. for 6 hours so that the heavy rare-earth compound was decomposed into heavy rare-earth and diffused into the magnet, and an infiltration reaction proceeded. Subsequently, the final heat treatment was performed at 500° C. for 2 hours. The magnet of which final boundary diffusion was completed was re-surface-processed to remove a residual diffusion layer, and then bonded using an epoxy bond to be 15*15*5 mmT.

The result of evaluating the magnetic properties and irreversible thermal demagnetization rate is shown in Table 1.

A sintered magnet of Comparative Example 1, illustrated in FIG. 2, has all three partitioned magnets 5 with the same coercive force and the same length.

The sintered magnet of Comparative Example 2 was manufactured under the same conditions as in Comparative Example 1.

A grain boundary diffusion process was performed to improve the coercive force characteristics. The diffusion was performed by adjusting the ratio of Dy-Hydride and alcohol to 50%:50%, the diffusion was performed in the same method as in Example 1 except for changing the diffusion material, and the magnet was bonded to be 15*15*5 mmT.

A sintered magnet of Comparative Example 2, illustrated in FIG. 3, has all three partitioned magnets 6 with the same coercive force and the same length.

The Nd sintered magnet of the present disclosure is characterized by having a state in which three or more partitioned magnets were bonded, having magnets corresponding to both ends and the other magnets formed of different materials, and having different coercive forces.

For example, the Nd sintered magnet according to the present disclosure, illustrated in FIG. 4, include three partitioned magnets with the same length that are bonded, where coercive forces of first magnets 11 corresponding to a first end and a second end of the magnet are greater coercive forces of a second magnet 12 corresponding to the central portion of the magnet.

By having these characteristics, a permanent magnet with a high coercive force specification may be applied to the edges of the magnet, which are relatively vulnerable to a reverse magnetic field, and a permanent magnet with a low coercive force specification may be applied to the central portion between the edges, thereby reducing the use of heavy rare-earth elements when the partitioned magnets are manufactured and reducing the manufacturing process cost.

The manufacturing was performed under the same conditions as in Comparative Example 1.

Thereafter, the 15*5*5 mmT magnet in which Tb-Hydride and Dy-Hydride were each diffused in the grain boundary diffusion process was manufactured, and as illustrated in FIG. 4, the partitioned bonded magnets were manufactured so that the magnet in which Dy-Hydride was diffused was positioned at the central portion and the magnets in which Tb-Hydride was diffused were positioned at both ends.

The Nd sintered magnet of the present disclosure, illustrated in FIG. 5, has three partitioned magnets that are bonded, where coercive forces of first magnets 21 corresponding to a first end and a second end of the magnet are greater coercive forces of a second magnet 22 corresponding to the central portion of the magnet.

In some implementations, a length of the second magnet 22 is greater than that of the first magnet 21. In this way, by adopting the length of the central portion differently, it is possible to prevent the mixing of the permanent magnet.

The manufacturing was performed in the same method under the same conditions as described in Comparative Example 1.

Thereafter, a 15*4.5*5 mmT magnet with Tb-Hydride diffused in the grain boundary diffusion process was manufactured, and a 15*6*5 mmT magnet with Dy-Hydride diffused was manufactured.

As illustrated in FIG. 5, the partitioned bonded magnet was manufactured so that the Dy-Hydride diffused magnet was positioned at the central portion and the Tb-Hydride diffused magnets were positioned at both ends.

The result of evaluating the magnetic properties and irreversible thermal demagnetization rate is shown in Table 1. The magnetic properties were measured at 20° C. according to IEC 60404-5.

TABLE 1

| | Diffusion | | | Thermal |
|---|---|---|---|---|
| Items | material | Br(kG) | Hcj(kOe) | demagnetization |
| Comparative | TbH | 13.5 | 26.5 | 0.85%(@170° C.) |
| Example 1 | | | | |
| Comparative | DyH | 13.6 | 24.5 | 0.52%(@157° C.) |
| Example 2 | | | | |
| Example 1 | TbH + DyH | 13.54 | 26.23 | 2.16%(@170° C.) |
| Example 2 | TbH + DyH | 13.56 | 26.18 | 3.38%(@170° C.) |

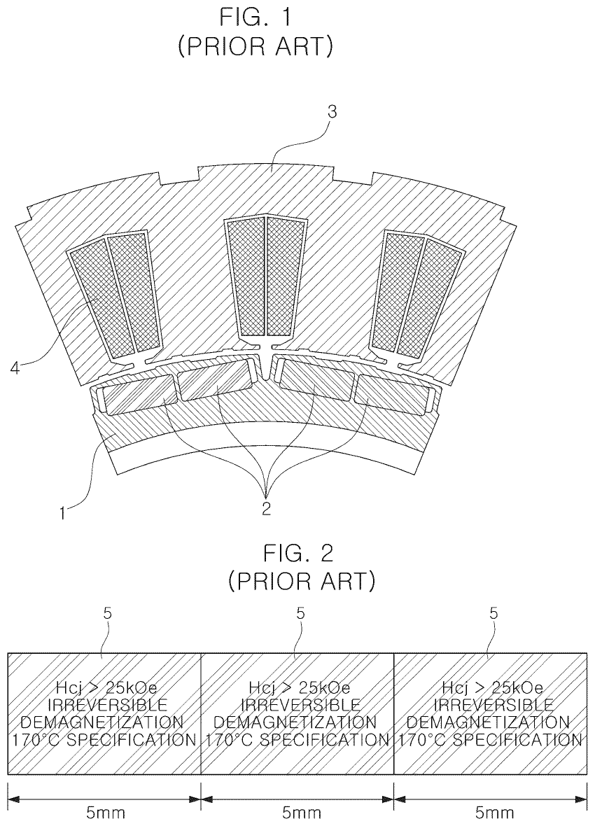

The Nd sintered magnet with a high coercive force using different materials proposed in the present disclosure was applied to both ends to compare a motor state demagnetization rate with the conventional partitioned magnet. A cross section of the driving motor is as illustrated in FIG. 1.

The size of the magnet inserted into the rotor of the motor was a=45, b=15, and c=6 mm.

Tables 2 and 3 show the demagnetization rates of the permanent magnets for each temperature (170° C. and 200° C.) and each D-axis applied current of the driving motors to which Comparative Example 1 and Examples 3 and 4 were applied.

The results are an example under specific conditions and are to refer to the trend of the demagnetization rate of the permanent magnet during operation of the motor according to the applied examples.

It can be confirmed that the demagnetization rates of Comparative Example 1 and Examples 3 and 4 have the same level regardless of the magnitude of the D-axis applied current.

TABLE 2

| | | 170° C. | | | |
|---|---|---|---|---|---|
| | | D-axis applied current (Arms) | | | |
| 170° C. | | 220 | 240 | 260 | 280 |
| Demagnetization | Comparative | 0.18 | 0.37 | 0.74 | 1.66 |
| rate | Example 1 | | | | |
| Demagnetization | Example 1 | 0.19 | 0.37 | 0.74 | 1.67 |
| rate | | | | | |
| Demagnetization | Example 2 | 0.19 | 0.37 | 0.74 | 1.67 |
| rate | | | | | |

TABLE 3

| | | 200° C. | | | |
|---|---|---|---|---|---|
| | | D-axis applied current (Arms) | | | |
| 200° C. | | 120 | 140 | 160 | 180 |
| Demagnetization | Comparative | 0 | 0.40 | 0.79 | 1.79 |
| rate | Example 1 | | | | |
| Demagnetization | Example 1 | 0.20 | 0.40 | 0.80 | 2.00 |
| rate | | | | | |
| Demagnetization | Example 2 | 0 | 0.40 | 0.80 | 1.80 |
| rate | | | | | |

Although the present disclosure has been described above with reference to the exemplary drawings, the present disclosure is not limited to the described implementations, and it is apparent to those skilled in the art that various modifications and changes can be made without departing from the spirit and scope of the present disclosure. Therefore, these modified examples or changed examples should be included in the claims of the present disclosure, and the scope of the present disclosure should be construed based on the appended claims.

What is claimed is:

1. A sintered magnet comprising one or more rare-earth elements,
wherein the sintered magnet is partitioned into three or more magnets,
wherein the three or more magnets comprise:
a pair of first magnets disposed at ends of the sintered magnet, respectively, the pair of first magnets being made of a first material, and
a second magnet disposed between the pair of first magnets, the second magnet being made of a second material different from the first material.

2. The sintered magnet of claim 1, wherein coercive force of each of the pair of first magnets is different from coercive force of the second magnet.

3. The sintered magnet of claim 2, wherein the one or more rare-earth elements comprise at least one of neodymium (Nd), Praseodymium (Pr), Lanthanum (La), Cerium (Ce), Holmium (Ho), Dysprosium (Dy), or Terbium (Tb).

4. The sintered magnet of claim 1, wherein the one or more rare-earth elements are neodymium (Nd).

5. The sintered magnet of claim 1, wherein the second magnet is bonded between the pair of first magnets.

6. The sintered magnet of claim 5, wherein coercive force of each of the pair of first magnets is different from coercive force of the second magnet.

7. The sintered magnet of claim 6, wherein the one or more rare-earth elements comprises at least one of neodymium (Nd), Praseodymium (Pr), Lanthanum (La), Cerium (Ce), Holmium (Ho), Dysprosium (Dy), or Terbium (Tb).

8. The sintered magnet of claim 6, wherein the one or more rare-earth elements are neodymium (Nd).

9. The sintered magnet of claim 7, which the sintered magnet is a permanent magnet disposed in a driving motor of an electric vehicle.

10. The sintered magnet of claim 6, wherein the coercive force of the second magnet is less than the coercive force of each of the pair of first magnets.

11. The sintered magnet of claim 10, wherein the coercive force of each of the pair of first magnets is greater than 25 kOe, and
wherein the coercive force of the second magnet is greater than 24 kOe.

12. The sintered magnet of claim 10, wherein a length of the second magnet is greater than a length of each of the pair of first magnets.

13. The sintered magnet of claim 5, wherein a length of the second magnet is greater than a length of each of the pair of first magnets.
